(19) United States
(12) Patent Application Publication
(10) Pub. No.: US 2002/0104294 A1
(43) Pub. Date: Aug. 8, 2002

(54) Cushioned cover for equestrian saddle

(76) Inventor: Connie Hainline, Bailey, CO (US)

Correspondence Address: RAMON L. PIZARRO, Suite 200, 3515 SOUTH TAMARAC DRIVE, DENVER, CO, 80237, US

(21) Appl. No.: 09/778,176

(22) Filed: Feb. 6, 2001

(51) Int. Cl. B68C 1/08; B68C 1/10

(52) U.S. Cl. 54/44.5

(57) ABSTRACT

A cover for an equestrian saddle, the cover including a flexible sleeve with a pocket adapted for creating a generally pear-shaped opening. The hollow flexible sleeve includes a pair of web sections, one web section extending from one of the sides of the sleeve towards the pocket and the other web extending from the remaining side and extending towards the pocket, the sleeve further having a chord adapted for attaching the sleeve to the equestrian saddle. An elongated gel cushion of substantially uniform thickness, the cushion being adapted for fitting within the hollow flexible sleeve, is also used with the sleeve.

### BACKGROUND OF THE INVENTION

(a) Field of the Invention

This invention generally relates to a removable cover for and equestrian saddle. More particularly, but not by way of limitation, to a removable cover for and equestrian saddle, the removable cover including a gel filled area.

(b) Discussion of Known Art

Equestrian saddles, which will be referred to herein as simply “saddles,” have been in use for hundreds of years. There are several well-known and widely used versions of the equestrian saddle. The Western saddle, which includes a front portion with a tree and a rear portion with a seat that includes a slightly raised back, is perhaps the most widely used saddle in the United States. The Western saddle is made primarily of heavy sections of leather with virtually no padding. Other saddle designs include the English type saddle, which is generally flat as compared to the Western saddle. The English saddle is also made primarily of leather, but includes more padding than is found in the Western saddle. Other saddle variations include certain South Eastern European or South American designs that include sheepskin covers or upper layers that are part of these saddles.

An enduring problem with known saddle designs is that the hard leather construction is very hard on the rider's seat and pelvic area. An important problem associated with providing cushioning material is that the added thickness of any padding material makes riding on the saddle rather uncomfortable. Furthermore, the addition of blankets or sheepskins can compromise the stability of the rider, by raising the center of gravity of the rider and by providing a slip or sliding interface between the saddle and the blanket, sheepskin, pillow or similar cushioning device.

Still further, many known approaches at cushioning saddles has been to add gel sections as shown in U.S. Pat. No. 5,363,631 to Garrison and U.S. Pat. No. 5,119,618 to Streck each teach saddle pads for horses that have a gel layer to absorb shock that is transmitted from the saddle on to the horse. Similar approaches can be found in French Patent 2,670,769, which teaches a saddlecloth with fluid-filled pads that are placed under the saddlecloth. Unfortunately, however, these devices do little to alleviate the impact of the saddle's surface against the rider's body. Other gel articles can be found in U.S. Pat. No. 4,380,569 to Shaw, issued Apr. 19, 1983, incorporated herein in its entirety by reference.

Many bicycle seat designers have taken advantage of the shock absorption properties of gel materials. Thus examples of devices such as the fluid filled bicycle seat shown in U.S. Pat. No. 4,504,089 are common. However, a horseback rider encounters problems that are far different than the problems encountered by the cyclist. The horseback rider has to use his legs and the interface between his legs and the stirrups to keep from falling from the horse, due to the movements of the horse's body.

In order to keep from falling from a horse during a gallop or difficult riding situation, a rider has to use his weight by standing on the stirrups. Often, the rider will also grasp a handle or saddle tree that is part of the saddle and pull against the handle or saddle tree while pressing his legs against the stirrups. This provides enhanced engagement of the rider against the saddle. Thus, the use of uniform pads or blankets that fit between the rider's legs widen the rider's stance over the horse and reduce the rider's ability to properly engage and cooperate with the saddle.

Therefore, a review of known devices reveals that there remains a need for a simple device that can be used over a saddle to soften or cushion the impact or contact between the rider and the saddle.

Still further, there remains a need for a device that can be used to soften the impact of a saddle on a rider without harming the stability of the rider on the saddle.

There remains a need for a saddle cushion system that can be placed over a saddle and which presents minimum impact on the rider's ability to press his feet against the stirrups.

### SUMMARY

It has been discovered that the problems left unanswered by known art can be solved by providing a cover for an equestrian saddle, the cover includes:

A hollow flexible sleeve having a front end, a rear end, and a pair of sides extending between the ends; and

An elongated cushion, the cushion that fits within the hollow flexible sleeve and includes a front portion and a rear portion, the front portion including approximately the front half of the cushion and the rear portion including approximately the rear half of the cushion. The front portion of the cushion is narrower than the rear portion, meaning that the front portion of the cushion extends from the rear portion to create a generally pear-shaped profile, with the narrow portion of the pear shape being the front portion of the cushion. The cushion is preferably removable and made of a gel type material.

According to one example of the invention, the front end of the flexible sleeve includes a tie or drawstring that extends along the sides and across the rear end of the sleeve. The tie or drawstring is particularly useful in connection with the Western saddle, where tie or drawstring can cooperate with the saddle tree to secure the sleeve over the saddle. Additionally, it is contemplated that, if a tie is used instead of a drawstring, the flexible sleeve will be made of a soft fabric that can conform to the contours of the saddle, whereas the tie will be of a much stiffer material, so that a pull on the tie will cause the edges or sides and end of the cover to pull the sleeve over the saddle to retain the sleeve or entire assembly on the saddle.

Thus, it will be understood that the disclosed invention provides a device that is simple to install and provides padding on the areas where contact between the rider and saddle are likely to be most acute. It is contemplated that the sleeve of the invention will include a web section next to the front portion of the cushion. The web section will be thin so as to prevent interference of the cushioned cover and the interaction of the rider's legs over the saddle and animal. In other words, the web section will be thin enough so as to allow the rider to keep his legs as straight as possible. This allows the rider to cooperate with the horse and saddle, allowing the rider to press his feet against the stirrups to add stability while riding.

The drawstring or stiffened border arrangement together with the sleeve arrangement allows removal of the cover from the saddle as well as the cushion from the sleeve to allow laundering of the sleeve.

It should also be understood that while the above and other advantages and results of the present invention will become apparent to those skilled in the art from the following detailed description and accompanying drawings, showing the contemplated novel construction, combinations and elements as herein described, and more particularly defined by the appended claims, it should be clearly understood that changes in the precise embodiments of the herein disclosed invention are meant to be included within the scope of the claims, except insofar as they may be precluded by the prior art.

### DRAWINGS

The accompanying drawings illustrate preferred embodiments of the present invention according to the best mode presently devised for making and using the instant invention, and in which:

FIG. 1 is a top, plan view of an example of the invention. The view illustrating the outline of the cushion within the sleeve.

FIG. 2 is a perspective view of the assembled cushioned cover for an equestrian saddle.

FIG. 3 is a side view of the cushion as used on a Western saddle.

FIG. 4 is a cross sectional view taken from the location indicated on FIG. 1.

### DETAILED DESCRIPTION OF PREFERRED EXEMPLAR EMBODIMENTS

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

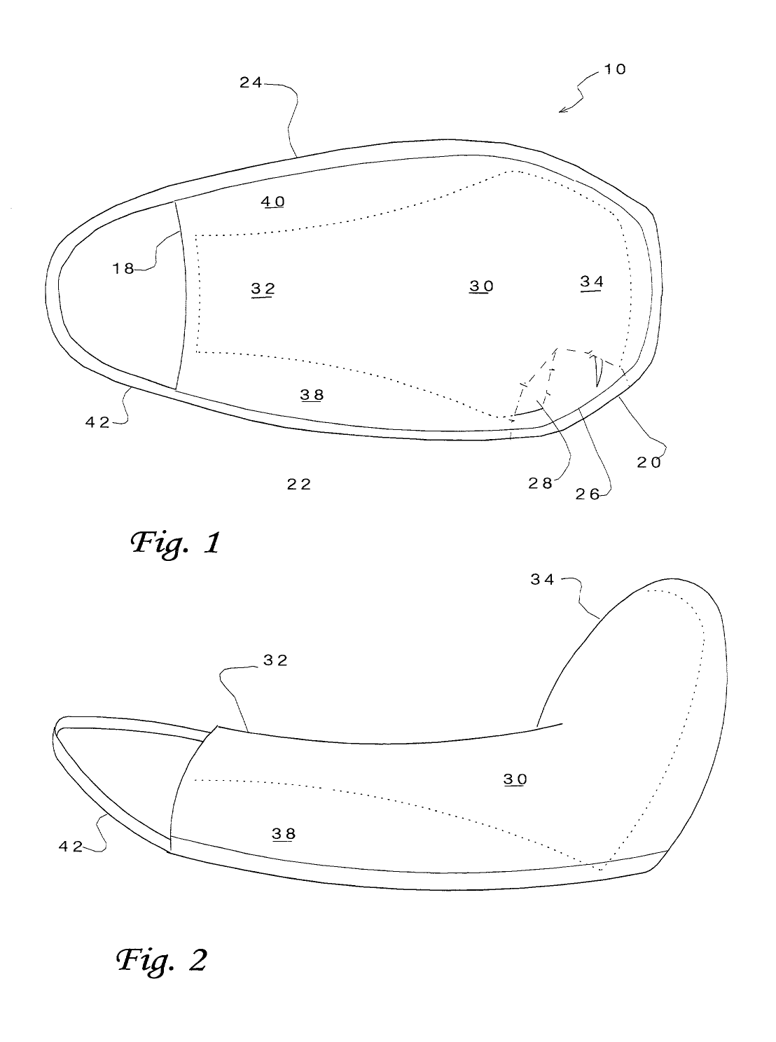

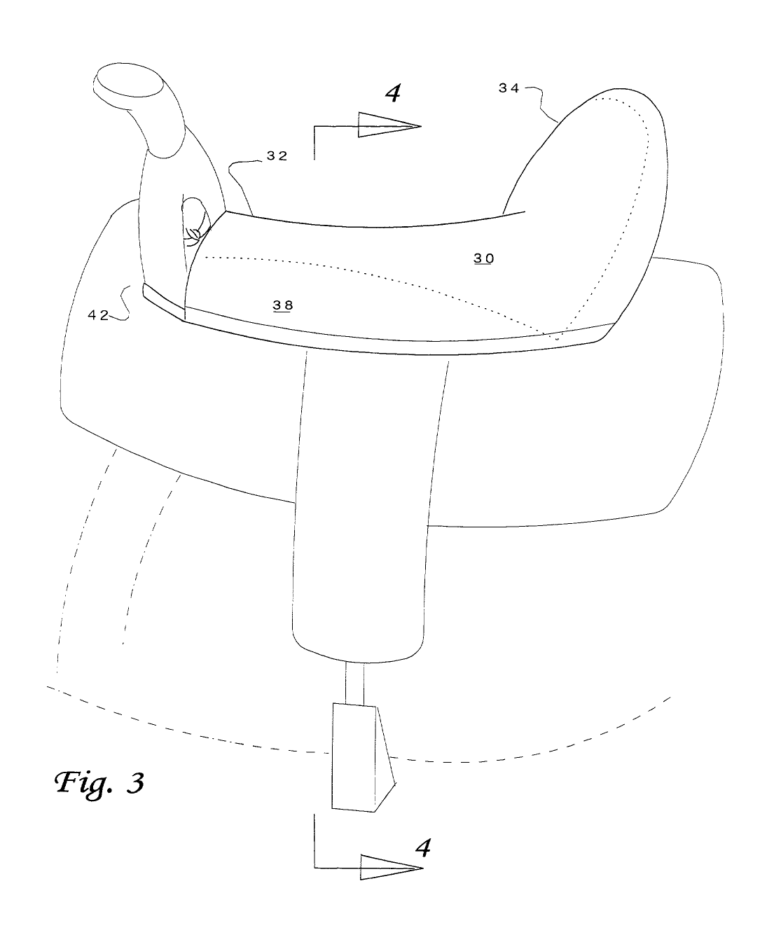

Turning now to FIGS. 1 and 2, where an example of a cover 10 for an equestrian saddle 12, such as the Western type equestrian saddle 14, shown on FIG. 3, has been illustrated. From these drawings it will be understood that the cover 10 includes a flexible sleeve 16 that includes a front end 18, a rear end 20, and a pair of sides 22 and 24. The sides 22 and 24 extend between the front end 18 and the rear end 20 to define a border or edge of the cover 10. It is further contemplated that the sleeve 16 will include a pocket 26 that is designed for accepting and holding a cushion 28. It is further contemplated that the cushion 28 may be formed from several sections of gel type material or individual packets of cushioning material, such as air cushions or foam cushions. The various types of cushions may be used to create a cushioned area 30 with varying firmness. Thus, the user may adjust or create a variation in firmness along the cushioned area. This will allow the user to customize the firmness of the cushioned area 30.

As can be understood from FIG. 1, the overall shape of the cushioned area 30, and hence the final shape of the cushion 28, would be of a generally pear-shape, meaning generally elongated and with approximately one half of the cushion 28 being narrower than the other half. In the illustrated configuration the front half or portion 32 of the cushion 28 is narrower than the rear portion 34 or half of the cushion 28. The thickness of the cushion 28 may vary, but it is contemplated that it will generally be of a uniform thickness.

Thus, the sleeve 16 will be designed for providing a generally pear-shaped opening or pocket 26 that will hold the cushion 28. The pocket 26 may be of a fixed configuration or be of an adjustable configuration. For example, sections of hook and loop material may be incorporated onto the interior surfaces of the pocket 26 to adjust the precise shape of the opening.

Also illustrated in FIGS. 1-4 is that it is contemplated that the flexible sleeve 16 will also include a pair of web sections 38 and 40, the web sections 38 and 40 extending from one of the sides 22 of the sleeve 16, towards the pocket 26, and the other web 40 extending from the remaining side 24 and extending towards the pocket 16. Thus, the webs 38 and 40 will allow the cover 10 to be extended over the saddle 12, and stabilize and center the cushioned area 30 over the saddle 12.

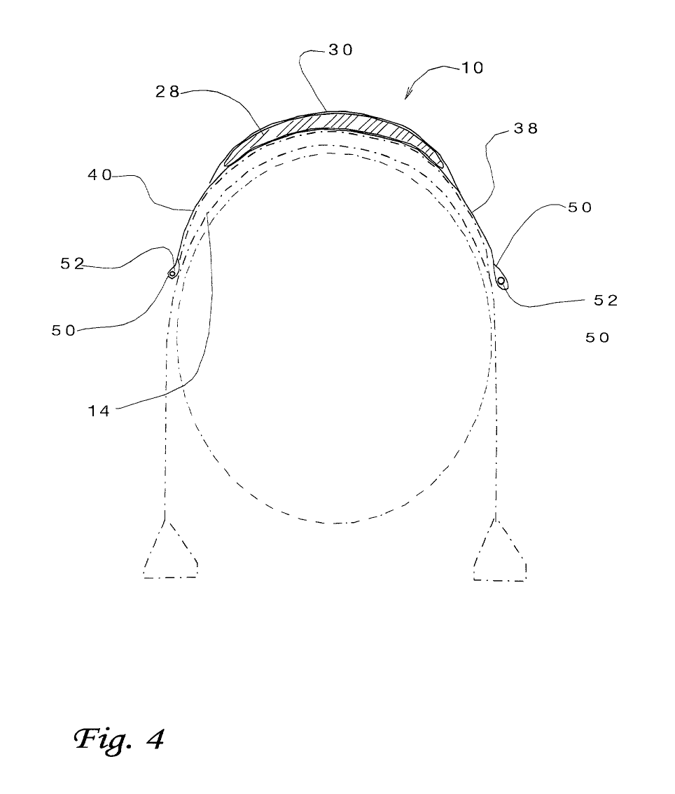

As illustrated in FIGS. 1 and 4, it is further contemplated that the sleeve 16 will also include a chord 42 that has been adapted for attaching the sleeve 16 to the equestrian saddle. Thus, as illustrated in FIG. 3, the chord 42 may cooperate with the saddle tree 44 to secure the cover 10 over the saddle 12. Also, as the chord 42 is pulled against the front of the saddle 12, meaning towards the saddle tree 44, the web sections 38 and 40 will allow the sleeve 16 to be drawn over the saddle 12 and provide stable retention of the cover 10 over the saddle 12 while creating minimum bulk over the saddle 12.

As illustrated in FIG. 4, it is further contemplated that the sleeve 16 will include friction-enhancing protrusions 48 on surfaces that contact the saddle 12. These friction enhancing protrusions may be areas of rubber beads or other materials that will reduce the slippage of the sleeve 16 over the saddle 12. Since it is contemplated that the sleeve 16 may be made of textile fabric, it is also contemplated that the protrusions 48 may be painted or printed on to the fabric. Still further, it is contemplated that the sleeve 16 will include a stiffened border 50 that will cooperate with the chord 42, so that on application of a tension force on the chord 42 results in a tightening of the border 50 over the saddle. Still further, as illustrated in FIG. 4, it is contemplated that the chord 42 may alternatively be attached to a drawstring 52 or elastic that extends through the stiffened border 50. Thus, it is contemplated that the stiffening of the stiffened border 50 may be supplied by the simple doubling up of material along the edges of the sleeve 16.

Thus it can be appreciated that the above described embodiments are illustrative of just a few of the numerous variations of arrangements of the disclosed elements used to carry out the disclosed invention. Moreover, while the invention has been particularly shown, described and illustrated in detail with reference to preferred embodiments and modifications thereof, it should be understood that the foregoing and other modifications are exemplary only, and that equivalent changes in form and detail may be made without departing from the true spirit and scope of the invention as claimed, except as precluded by the prior art.

What is claimed is:

1. A cover for an equestrian saddle, the cover comprising:
a flexible sleeve having a front end, a rear end, and a pair of sides extending between the front end and the rear end, the sleeve further having a pocket adapted for creating a generally pear-shaped opening, the hollow flexible sleeve further having a pair of web sections, one web section extending from one of the sides of the sleeve towards the pocket and the other web extending from the remaining side and extending towards the pocket, the sleeve further having a chord adapted for attaching the sleeve to the equestrian saddle; and
an elongated cushion of substantially uniform thickness, the cushion being adapted for fitting within the hollow flexible sleeve.

2. A device according to claim 1 wherein the front portion of said elongated cushion accounts for approximately half of the cushion and the rear portion of said elongated cushion accounts for approximately half of the rear portion of the cushion.

3. A device according to claim 1 wherein the cushion is made of a gel type material.

4. A device according to claim 1 wherein said sleeve includes an aperture adapted for allowing insertion and removal of said cushion.

5. A device according to claim 1 and further comprising friction enhancing protrusions on a surface of said cover.

6. A device according to claim 1 and further comprising a stiffened border that includes the sides and the rear end of said sleeve, the chord being attached to said stiffened border, so that tension on the chord results in a tightening of the border over the saddle.

7. A cover for an equestrian saddle, the cover comprising:
a flexible sleeve having a front end, a rear end, and a pair of sides extending between the front end and the rear end, the sleeve further having a pocket adapted for creating a generally pear-shaped opening, the hollow flexible sleeve further having a pair of web sections, one web section extending from one of the sides of the sleeve towards the pocket and the other web extending from the remaining side and extending towards the pocket, the sleeve further having a chord adapted for attaching the sleeve to the equestrian saddle; and
an elongated cushion of substantially uniform thickness, the cushion being adapted for fitting within the hollow flexible sleeve, the cushion including a front portion and a rear portion, the front portion being narrower than the rear portion and extending from the rear portion to define a generally pear shaped profile.

8. A device according to claim 7 wherein the front portion of said elongated cushion accounts for approximately half of the cushion and the rear portion of said elongated cushion accounts for approximately half of the rear portion of the cushion.

9. A device according to claim 8 wherein the cushion is made of at least one section of a gel type material.

10. A device according to claim 7 wherein said sleeve includes an aperture adapted for allowing insertion and removal of said cushion.

11. A device according to claim 7 and further comprising friction enhancing protrusions on a surface of said cover.

12. A device according to claim 11 and further comprising a stiffened border that includes the sides and the rear end of said sleeve, the chord being attached to said stiffened border, so that tension on the chord results in a tightening of the border over the saddle.

13. A method for creating a cover for an equestrian saddle, the method comprising:
providing a hollow flexible sleeve having a front end, a rear end, and a pair of sides extending between the front end and the rear end, the sleeve further having a pocket adapted for creating a generally pear-shaped opening, the hollow flexible sleeve further having a pair of web sections, one web section extending from one of the sides of the sleeve towards the pocket and the other web extending from the remaining side and extending towards the pocket, the sleeve further having a chord adapted for attaching the sleeve to the equestrian saddle;
providing an elongated cushion of substantially uniform thickness; and,
inserting the cushion within the hollow flexible sleeve, so that the cushion is held between the web sections of the sleeve.

14. A method according to claim 13 wherein the front portion of said elongated cushion accounts for approximately half of the cushion and the rear portion of said elongated cushion accounts for approximately half of the rear portion of the cushion.

15. A method according to claim 14 wherein the cushion is made of multiple sections of a cushion material.

16. A method according to claim 15 wherein said sleeve includes an aperture adapted for allowing insertion and removal of said sections of cushion material.

17. A method according to claim 14 and further comprising friction enhancing protrusions on a surface of said cover.

18. A method according to claim 14 and further comprising providing a stiffened border that includes the sides and the rear end of said sleeve, the chord being attached to said stiffened border, so that tension on the chord results in a tightening of the border over the saddle.
